(19) United States
(12) Patent Application Publication
(10) Pub. No.: US 2010/0283271 A1
(43) Pub. Date: Nov. 11, 2010

(54) STRIKER WITH ROUND ANTICHUCK BUMPER

(76) Inventors: Todd Hemingway, Metamora, MI (US); Walter Pipp, Birmingham, MI (US)

Correspondence Address: MCDONALD HOPKINS LLC, 600 Superior Avenue, East, Suite 2100, CLEVELAND, OH, 44114-2653, US

(21) Appl. No.: 12/774,431

(22) Filed: May 5, 2010

Related U.S. Application Data
(60) Provisional application No. 61/215,429, filed on May 5, 2009.

(51) Int. Cl. E05B 15/02

(52) U.S. Cl. 292/341.15

(57) ABSTRACT

A striker having a bumper for mounting to a support structure and for engagement with a latch mechanism is described. The striker includes improved noise and vibration control characteristics to reduce or eliminate chucking, squeak and rattle concerns. The striker may include a base, a bumper post, a post, a bridge, and a bumper. The base may include at least one aperture for connecting the base to the support structure. The bumper post may extend outwardly from the base. The post may extend outwardly from the base and be engageable with the latch mechanism. The bridge may extend between the bumper post and post at a distance away from the base, wherein the bridge may be engageable with a fishmouth of the latch mechanism. The bumper may be rotatably connected to the bumper post, wherein the bumper may be capable of wedged engagement with an entrance of the latch mechanism.

### CROSS-REFERENCE TO RELATED APPLICATION

This application claims benefit from U.S. Provisional Patent Application No. 61/215,429, entitled “Striker With Round Antichuck Bumper,” filed on May 5, 2009, which is hereby incorporated by reference in its entirety.

### FIELD OF INVENTION

The present invention is generally related to strikers and, more particularly, to strikers with improved noise and vibration characteristics.

### BACKGROUND

Many vehicles with doors, liftgates, or the like, suffer from distortion of the rear end of the vehicle as the vehicle runs over a rough surface. This distortion causes significant deflection of the door relative to the door opening. This deflection may often be large enough for contact to be made between the door and the opening or at a high enough frequency that noise is emitted from the system.

A variety of latching mechanisms have been used within the automotive industry for releasably coupling various movable components to the vehicle body. For example, latches are used for releasably coupling doors (e.g. passenger doors, liftgate, hood, trunk, etc.) to vehicles. In general, the latching mechanisms are operable in a latched mode to secure the door to the vehicle body and in an unlatched mode where the door is freely movable relative to the vehicle body. These latching mechanisms may typically include a latch for engaging a striker when the door is in a closed position. The latch may typically be secured near an edge of the door, and a striker may typically be secured to the vehicle body.

Generally, only one edge of a door is releasably coupled to the vehicle body by way of one or more hinge mechanisms or the like. A latch is typically mounted to the edge opposite that of the hinge mechanism. The side edges of the door are generally not hinged or physically connected to the vehicle body. Therefore, motion of the vehicle can result in “match-boxing”, non-parallel deflection of the vehicle body relative to the side edges of the door, or relative motion been the door and the vehicle body. This relative motion is undesirable, in part, because it imparts additional vehicle noise, known as “chucking”, as the vehicle travels along rough or uneven surfaces.

Manufacturers often employ a variety of anti-chucking hardware to reduce the chucking resulting from match-box deflection. One attempt at reducing chucking involves providing a fishmouth of the latch with features to reduce the clearance between the striker bridge and fishmouth. Reducing the clearance between the two may control and minimize the relative motion between the striker and the latch.

Typically, the interior walls of the fishmouth are provided with hard plastic flaps that are backed by an elastomeric material, which provides stiffness with compliance. These flaps may allow the housing to be more compliant while being more durable than just an elastomer. This allows the fishmouth to conform to the striker bridge to enhance the engagement between the striker and the latch. This system, however, may have limited effectiveness in the absence of corresponding protruding features included in the striker bridge.

Another attempt at reducing chucking involves providing anti-chucking hardware, such as wedges and spring-loaded bumpers that may be positioned between the door edges and the vehicle body. Utilizing wedges and bumpers may deflect some of the load from the match-boxing to the door. Some latches may also have a moveable wedge driven by a spring, whereby the wedge is designed to continually tighten against the striker to maintain zero clearance within the given gap.

In some instances, the door dynamics and loading may be so severe that the wedges and bumpers can be bounced out of position, thereby becoming completely ineffective. In addition, dirt and ice frequently compound this problem by further urging the wedges and/or bumpers out of position. Often, bumpers may be worn down, whereby the bumper may no longer be effective at reducing noise and vibration.

### SUMMARY

A striker having a bumper for mounting to a support structure and for engagement with a latch mechanism is described. The striker includes improved noise and vibration control characteristics to reduce or eliminate chucking, squeak and rattle concerns. The striker may include a base, a bumper post, a post, a bridge, and a bumper. The base may include at least one aperture for connecting the base to the support structure. The bumper post may extend outwardly from the base. The post may extend outwardly from the base and be engageable with the latch mechanism. The bridge may extend between the bumper post and post at a distance away from the base, wherein the bridge may be engageable with a fishmouth of the latch mechanism. The bumper may be rotatably connected to the bumper post, wherein the bumper may be capable of wedged engagement with an entrance of the latch mechanism.

### BRIEF DESCRIPTION OF THE DRAWINGS

Objects and advantages together with the operation of the invention may be better understood by reference to the following detailed description taken in connection with the following illustrations, wherein:

FIG. 1 illustrates a perspective view of a striker having a bumper.

FIG. 2 illustrates a side view of the striker of FIG. 1.

FIG. 3 illustrates a front view of the striker of FIG. 1.

FIG. 4 illustrates a top view of the striker of FIG. 1.

FIG. 5 illustrates a top cut away of an environmental view of a striker having a bumper.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

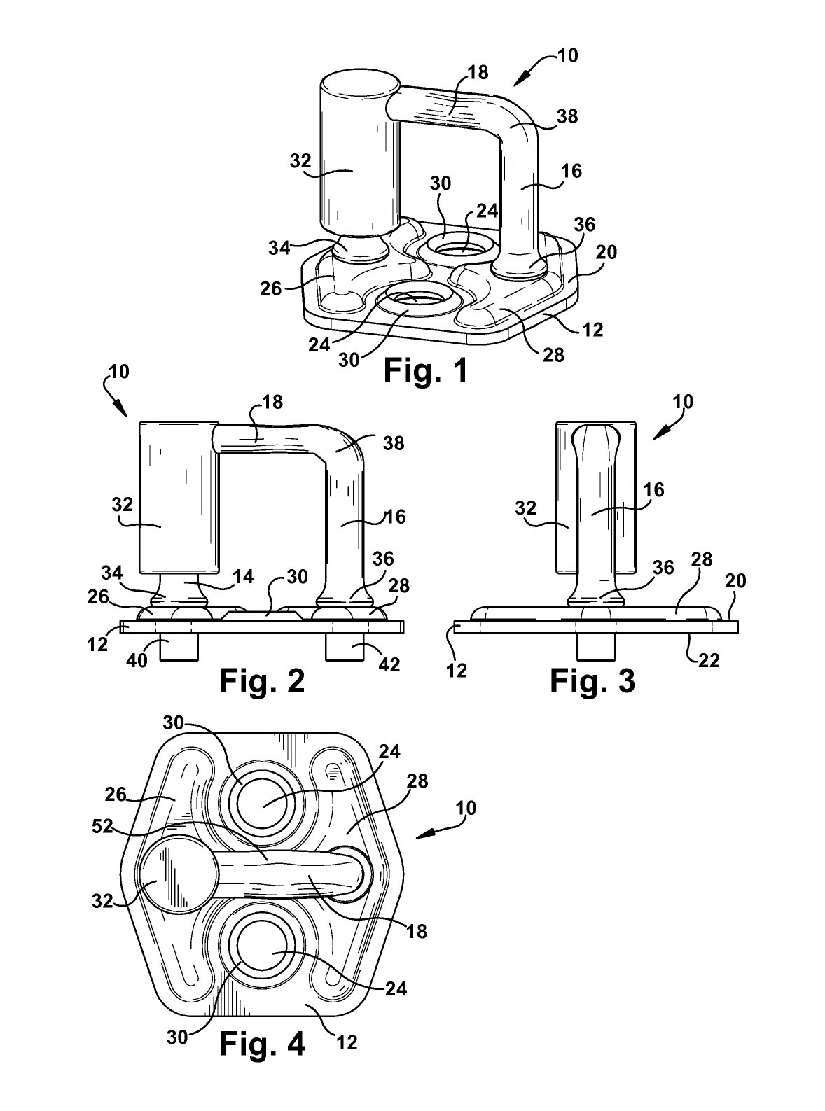

A striker 10 with dampening features is illustrated in FIGS. 1-5. The striker 10 may include improved noise and vibration control characteristics and be designed to reduce or eliminate chucking, squeak and rattle concerns in a door closure. The striker 10 may be of any appropriate shape, size or configuration. The striker 10 may include a base 12, a bumper post 14, a post 16 and a bridge 18 (FIGS. 1 and 2).

The base 12 may serve as a mounting structure for the striker 10. The base 12 may be of any appropriate shape, size or configuration, such as being of a generally planar configuration (FIG. 1). For example, the base 12 may be of a generally polygonal shape (FIG. 4). The base 12 may include a first or upper side 20, a second or lower side 22 and at least one aperture 24 (FIGS. 1-4). The base 12 may include any appropriate number of apertures 24, such as one, three, four, etc. For example, the base 12 may include two apertures 24.

The apertures 24 may permit the striker 10 to be mounted to or secured to a surrounding structure, such as a doorframe of an automobile body or the like. The striker 10 may be secured to this surrounding structure by way of fasteners (not shown). The fasteners may be of any appropriate shape, size or type. The fasteners may be passed through the apertures 24 in the base 12 and be used to mount the striker 10 to the surrounding structure.

The apertures 24 may be of any appropriate shape, size or configuration, such as a generally circular, rectangular or ovular shape. The apertures 24 may be located at any appropriate position on the base 12, whereby an aperture 24 may be located on each side of the base 12 when viewed from above (FIG. 4). Each aperture 24 may include a rim 30 (FIGS. 1, 2 and 4).

The rims 30 may be of any appropriate shape, size or configuration, such as a generally triangular or coned shape, whereby the rims 30 narrow towards a point extending away from the apertures 24. The rims 30 may be located at any appropriate position on the striker 10, such as on the first side 20 of the base and extending approximately perpendicularly away from the first side 20.

The base 12 may further include a first boss 26 and a second boss 28 (FIGS. 1, 2 and 4). The bosses 26, 28 may be of any appropriate shape, size or configuration, such as oblong, circular, triangular, rectangular or a combination of the same. The bosses 26, 28 may be of similar shapes and sizes or may be of differing shapes and sizes. The bosses 26, 28 may be located at any appropriate position on the striker 10, such as on the first side 20 of the base 12 and extending approximately perpendicularly outward away from the first side 20 of the base 12. The bosses 26, 28 may generally provide additional structural characteristics to the striker 10.

The bumper post 14 may be of any appropriate shape, size or configuration. For example, the bumper post 14 may be of a generally cylindrical shape (FIG. 2). The base 12 and the bumper post 14 may be fabricated out of any appropriate type of material. The base 12 and bumper post 14 may be fabricated as a single integral piece of material. Alternatively, the base 12 and bumper post 14 may be fabricated as separate pieces that may be secured to one another by any appropriate means, such as by welding, riveting, adhesives, fasteners, and the like.

The bumper post 14 may be located at any appropriate position on the striker 10. For example, the bumper post 14 may be located on the first side 20 of the base 12 and may extend approximately perpendicularly out and away from the first side 20 of the base 12 (FIG. 2). The bumper post 14 may also be located within or adjacent to the first boss 26 and secured thereto by any appropriate means, such as by stamping, welding, fasteners, adhesives, and the like.

The bumper post 14 may also include a bumper post base 34 (FIGS. 1 and 2). The bumper post base 34 may be of any appropriate shape, size or configuration, such as a generally enlarged area as compared to the bumper post 14. The bumper post base 34 may be located at any appropriate position on the bumper post 14, such as adjacent to or abutted with the first boss 26 (FIGS. 1 and 2).

As an alternative, the striker 10 may include a back wall (not shown) in place of or in addition to the bumper post 14. The back wall or bumper post 14 may be utilized as an additional mounting structure or surface through which the fasteners may be passed or extended to mount and secure the striker 10 to a body.

The post 16 may be of any appropriate shape, size or configuration. For example, the exterior configuration of the post 16 may be of a generally cylindrical shape whereby the post 16 may easily engage with the catch 50 of a latch 44 (FIGS. 1-3 and 5). It is to be understood, however, that any other configuration or shape of the post 16 is possible, including but not limited to oblate, elliptical, spherical, square, rectangular, triangular, and the like.

The base 12 and the post 16 may be fabricated out of any appropriate type of material. The base 12 and post 16 may be fabricated as a single integral piece of material. Alternatively, the base 12 and post 16 may be fabricated as separate pieces that may be secured to one another by any appropriate means, such as by welding, riveting, adhesives, fasteners, and the like. As a further alternative, the base 12, bumper post 14, bridge 18, and post 16 may be formed from a single integral piece of material.

The post 16 may be located at any appropriate position on the striker 10. For example, the post 16 may be located on the first side 20 of the base 12 and may extend approximately perpendicularly out and away from the first side 20 of the base 12 (FIG. 2). The post 16 may be located substantially parallel to the bumper post 14 (FIG. 2). The post 16 may also be located within or adjacent to the second boss 28 and secured thereto by any appropriate means, such as by stamping, welding, riveting, fasteners, adhesives, and the like.

The post 16 may also include a post base 36 (FIGS. 1-3). The post base 36 may be of any appropriate shape, size or configuration, such as a generally enlarged area as compared to the post 16. The post base 36 may be located at any appropriate position on the post 16, such as adjacent to or abutted with the second boss 28 (FIGS. 1-3).

The bridge 18 may be of any appropriate shape, size or configuration. For example, the bridge 18 may be of a generally cylindrical, rectangular, triangular shape or the like (FIGS. 1, 2 and 4). The bridge 18 may be located at any appropriate position on the striker 10. For example, the bridge 18 may be located and extend between the bumper post 14 and post 16, whereby the bridge 18 may be located substantially parallel to the base 12 (FIG. 2). The bridge 18 may be connected to the bumper post 14 and post 16 by any appropriate means, such as by welding, adhesives, fasteners, and the like. However, it will be appreciated that the bridge 18, bumper post 14 and post 16 may be a single integral piece of material.

The striker 10 may include a corner portion 38 (FIGS. 1 and 2). The corner portion 38 may be of any appropriate shape, size or configuration. For example, the corner portion 38 may be of a generally cylindrical, rectangular, oblong or curved shape (FIGS. 1 and 2). The corner portion 38 may be located at any appropriate position on the striker 10. For example, the corner portion 38 may be located between the bridge 18 and post 16, whereby the corner portion 38 may connect the bridge 18 to the post 16 (FIGS. 1 and 2).

The corner portion 38 may be connected to the bridge 18 and post 16 by any appropriate means, such as by welding, adhesives, fasteners, and the like. However, it will be appreciated that the corner portion 38, bridge 18 and post 16 may be a single integral piece of material, whereby the corner portion 38 may connect the bridge 18 to the post 16 in a seamless transition.

As an alternative, the striker 10 may include a bumper post tenon 40 and a post tenon 42 (FIG. 2), such that may be part of a rivet. The bumper post tenon 40 and post tenon 42 may be of any appropriate shape, size or configuration, such as generally cylindrical, triangular, square or the like. The bumper post tenon 40 and post tenon 42 may be located at any appropriate position on the striker 10, such as on the second side 22 of the body 12 (FIG. 2). For example, the bumper post tenon 40 may be located opposite that of the bumper post 14 and the post tenon 42 may be located opposite that of the post 16, whereby the bumper post tenon 40 may be approximately parallel to the post tenon 42.

The bumper post tenon 40 and post tenon 42 may be fabricated out of any appropriate type of material. The bumper post tenon 40 and post tenon 42 may be fabricated as a single integral piece of material with the bumper post 14 and post 16, respectively, whereby the bumper post 14 and post 16 may extend through the body 12 to comprise the bumper post tenon 40 and post tenon 42, respectively. Alternatively, the bumper post tenon 40 and post tenon 42 may be fabricated as separate pieces that may be secured to the bumper post 14 and post 16, respectively, or to the body 12 by any appropriate means, such as by welding, riveting, adhesives, fasteners, and the like.

The tenons 40, 42 may be utilized as additional features to maintain and secure the bumper post 14 and post 16 to the base 12 of the striker 10. While the tenons 40, 42 are illustrated as being unspun, it is to be understood that the tenons 40, 42 may be spun, whereby they would provide a larger diameter than the posts 14, 16 within the body 12 to maintain the posts 14, 16 location therein.

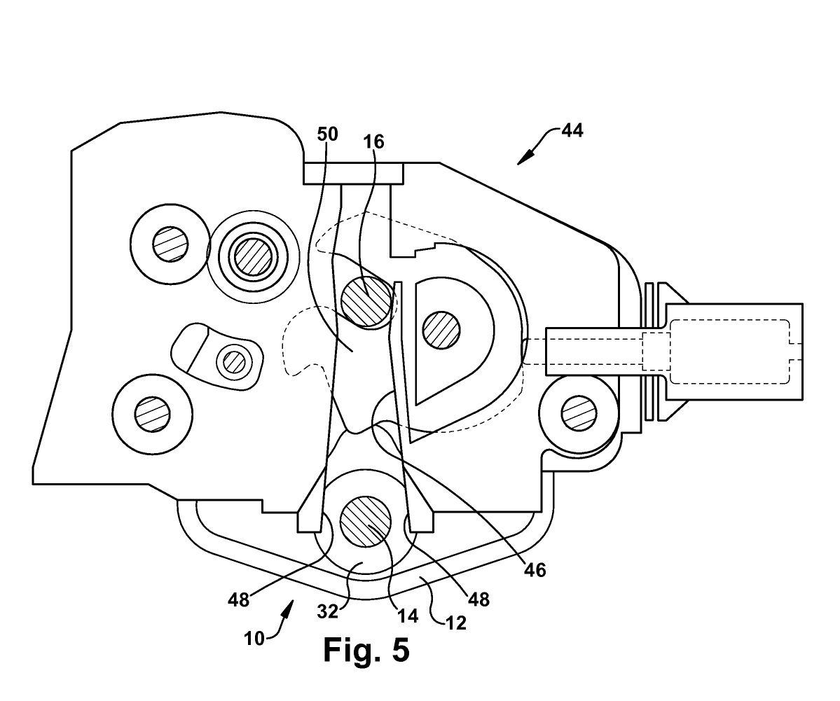

The striker 10 may be configured to engage a latch 44 (FIG. 5). Specifically, the bridge 18 and post 16 may be shaped and sized to engage a fishmouth 46 of the latch 44. The latch structure 44 may engage the striker 10, whereby an entrance or inner walls 48 of the latch 44 may approach the bumper post 14 and bumper 32. The engagement between the bumper 32 and the inner walls 48 of the latch 44 may allow for noise and vibration such as rattling or chucking.

To reduce noise and vibration, the bridge 18 may also include a contoured profile or projection 52 on one or both sides that may projects outward relative to the centerline of the bridge 18 (FIG. 4). When the striker 10 is fully engaged with the latch 44, such as a fishmouth latch, the projection(s) 52 may exert pressure on a corresponding interior wall of the fishmouth 46. This engagement between the projection 52 and fishmouth 46 may reduce noise, vibration and chucking U.S. patent application Ser. No. 11/732,351, which is herein incorporated by reference in its entirety, describes in further detail such bridge protrusions, various design options for such bridge protrusions and their mode(s) of operation.

The striker 10 may further include a bumper 32 (FIGS. 1-4). The bumper 32 may be of any appropriate shape, size or configuration. For example, the bumper 32 may be of a generally cylindrical shape that may be of a larger diameter than that of the bumper post 14 (FIG. 2). The bumper 32 may be fabricated out of any appropriate type of material. For example, the bumper 32 may be fabricated out of an elastic material, such as an elastomer or rubber. However, the bumper 32 may be fabricated out of any material useful in damping noise and vibration. The bumper 32 may be located at any appropriate position on the striker 10, such as surrounding a portion of the bumper post 14 (FIGS. 1 and 2).

The bumper 32 may assist in reducing noise, vibration and chucking between the latch 44, such as the inner walls 48 of the latch 44, and the striker 10. The bumper 32 may be adapted to dampen the interface between the striker 10 and the latch 44. To that end, the bumper 32 may engage the bumper post 14 to dampen the engagement between the bumper post 14 and the inner walls 48 of the latch 44. For example, the bumper 32 may cover the surface of the bumper post 14, extending from near the base 12 up to or past the intersection of the bridge 18 and the bumper post 14.

Typically, bumpers have been designed to dampen the engagement between the striker 10 and the latch 44. Often these bumpers may be attached to a back wall and include a wedged configuration. The wedged configuration may then engage the latch opening to dampen noise and vibration. U.S. patent application Ser. No. 12/316,225, which is herein incorporated by reference in its entirety, describes in further detail an embodiment of a wedge type bumper.

All bumpers, including wedge type bumpers, may be subject to wear from prolonged use. Specifically, for strikers 10 and latches 44 in use with car doors, the prolonged closed state of the door may cause deformation of the bumper, thereby decreasing the bumper's ability to reduce noise and vibration. Further, wedge type bumpers may often be prone to catching on the latch housing during opening and closing of the door, which may lead to deformation of the bumper.

To decrease wear on the bumper 32 and increase its lifespan, the engagement between the bumper 32 and the bumper post 14 may be designed to allow the bumper 32 to rotate about the bumper post 14. For example, the bumper post 14 may be cylindrical in shape (FIG. 1). The bumper 32 may be engaged with, but not be fixedly connected to the bumper post 14, thereby allowing the bumper 32 to rotate about the bumper post 14. While FIG. 1 may depict a portion of the bumper 32 as extending above the connection between the bumper post 14 and the bridge 18, it will be appreciated that the bumper 32 may alternatively stop below the bridge 18, whereby the bumper 32 may be permitted to rotate about the bumper post 14.

The bumper 32 may be rotatably connected to the bumper post 14 by any appropriate means. The bumper 32 may also be configured to turn or rotate on its own during normal use of the striker 10 and latch 44. For example, the bumper 32 may be loosely engaged with the bumper post 14 to allow free rotation of the bumper 32 about the bumper post 14. Alternatively, the bumper 32 may be elastically tight around the bumper post 14, yet loose enough to be manually rotated if desired.

Further, while the bumper post 14 may be illustrated as being cylindrical, it will be appreciated that the bumper post 14 may be any shape, such as oblate, elliptical, spherical, square, rectangular, triangular, or any shape to allow the bumper 32 to rotate. By allowing the bumper 32 to rotate about the bumper post 14, wear may be distributed about the entire surface of the bumper 32 and not be limited to specific areas where the bumper 32 may be engaged with the latch 44. The bumper 32 may be sized and shaped such that the engagement between the bumper 32 and the entrance or inner walls 48 of the latch 44 may dampen noise and vibration between the striker 10 and the latch 44. Although the embodiments of the present invention have been illustrated in the accompanying drawings and described in the foregoing detailed description, it is to be understood that the present invention is not to be limited to the embodiments disclosed, but that the invention described herein is capable of numerous rearrangements, modifications and substitutions without departing from the scope of claims hereafter.

1. A striker for mounting to a support structure and for engagement with a latch mechanism, said striker comprising:
a base having at least one aperture for connecting said base to the support structure;
a bumper post extending outwardly from said base;
a post extending outwardly from said base and engageable with the latch mechanism;
a bridge extending between said bumper post and said post at a distance away from said base, wherein said bridge is engageable with a fishmouth of the latch mechanism; and
a bumper rotatably connected to said bumper post, wherein said bumper is capable of wedged engagement with an entrance of the latch mechanism.

2. The striker of claim 1, wherein said bumper is cylindrical.

3. The striker of claim 2, wherein said bumper is rotatably engaged with the entrance of the latch mechanism.

4. The striker of claim 1, wherein said bumper comprises a pliable material.

5. The striker of claim 1 further comprising a first boss located adjacent said bumper post.

6. The striker of claim 1 further comprising a second boss located adjacent said post.

7. The striker of claim 1, wherein said bumper prevents side-to-side motion in the latch mechanism.

8. The striker of claim 1, wherein said bumper post is integrally formed with said base.

9. The striker of claim 8, wherein said post is integrally formed with said base.

10. The striker of claim 9, where said bridge is integrally formed with said bumper post and said post.

11. The striker of claim 1, wherein said bridge includes at least one protrusion located along a side of said bridge, wherein said at least one protrusion is capable of wedged engagement with the fishmouth.

12. A striker for mounting to a support structure and for engagement with a latch mechanism, said striker comprising:
a base having an upper side, a lower side, and at least one aperture for connecting said base to the support structure;
a bumper post extending outwardly from said upper side of said base;
a post extending outwardly from said upper side of said base and engageable with the latch mechanism;
a bridge extending between said bumper post and said post at a distance away from said base, wherein said bridge is engageable with a fishmouth of the latch mechanism; and
a bumper rotatably connected to said bumper post, wherein said bumper is capable of wedged engagement with an entrance of the latch mechanism; and
at least one tenon extending outwardly from said lower side of said base.

13. The striker of claim 12, wherein said bumper post and said post extend approximately perpendicularly out from said base.

14. The striker of claim 13, wherein said bumper post and said post are located approximately parallel to each other.

15. The striker of claim 12 further comprising a pair of tenons.

16. The striker of claim 15, wherein said pair of tenons includes a bumper post tenon extending away from said bumper post.

17. The striker of claim 16, wherein said bumper post tenon and said bumper post are integrally formed.

18. The striker of claim 12, wherein said bumper is rotatably engaged with the latch mechanism.

19. The striker of claim 12, wherein said bumper prevents side-to-side motion in the latch mechanism.
